(19) United States
(12) Patent Application Publication
(10) Pub. No.: US 2011/0008536 A1
(43) Pub. Date: Jan. 13, 2011

(54) PREPARATION OF MICROCAPSULE USING PHASE CHANGE MATERIAL

(75) Inventor: Joon-Taek OH, Seoul (KR)

Correspondence Address: HOLME ROBERTS & OWEN LLP, 1700 LINCOLN STREET, SUITE 4100, DENVER, CO, 80203, US

(73) Assignee: Enet Co., Ltd., Nonsan-si (KR)

(21) Appl. No.: 12/879,929

(22) Filed: Sep. 10, 2010

Related U.S. Application Data
(63) Continuation of application No. 11/572,345, filed on Mar. 12, 2008, now abandoned.

(30) Foreign Application Priority Data
Jul. 21, 2004 (KR) 10-2004-0056752

(51) Int. Cl. B01J 13/02

(52) U.S. Cl. 427/213.31

(57) ABSTRACT

Disclosed is a method for preparing a microcapsule containing a phase change material, comprising: a first encapsulation stage comprising adding a phase change material of 3-50% to a surfactant-containing solution of 0.1-10 wt% of water, adding a first monomer of 10-40%by weight of the phase change material to the solution so as to form an emulsified mixture, and adding an initiator of 0.005-1.0 wt% to the mixture, followed by polymerization; and a second encapsulation stage comprising adding a second monomer of 20-50% by weight of the phase change material, and adding an aldehyde- or dEsocyanate-containing compound of 30-500% by weight of the second monomer, followed by crosslinking. The microcapsule includes two coating layers for protecting the phase change material, so that the phase change material present within the microcapsule does not leak to the outside. Also, the microcapsule has a compact structure and can be prepared in the form of a particle having a size of the micrometer level or smaller, so that it has high thermal conductivity leading to high thermoresponsivity.

### TECHNICAL FIELD

The present invention relates, in general, to a method for preparing a microcapsule containing a phase change material and, more particularly, to a method comprising first encapsulating an organic phase change material by polymerizing a monomer, and further encapsulating the first encapsulated phase change material with another monomer.

### BACKGROUND ART

As petroleum and coal are continuously becoming exhausted, many efforts to solve the problem of energy exhaustion have been made in the world, and studies on new energy sources to solve this energy problem are being actively conducted. Preceding these studies, however, studies to increase the efficiency of use of a given amount of energy are urgently needed.

For this efficient utilization of energy, the efficient utilization of energy converters and the development of methods for energy storage and transfer are needed. Particularly, to accommodate the discrepancies of time and place between the supply and consumption of energy, the development of methods for storing energy is urgently needed. These energy storage methods can be broadly divided into the following three categories: a mechanical storage method using kinetic energy and potential energy; a chemical storage method for storing energy using chemical substances; and a storage method for storing thermal energy using sensible heat and latent heat.

Meanwhile, a method of adding new heat transfer media with high heat capacity can be considered to be effective for the maximization of energy efficiency. Studies on such heat transfer media have been steadily conducted, and recently, many studies have concentrated on the use of phase change material (PCM) for latent heat storage.

As used herein, the term “phase change material” refers to a material that absorbs or releases a large amount of heat at a specific temperature accompanied by a change in phase without a change in temperature. The absorbed or released heat is commonly referred to as latent heat

The latent heat storage method of storing thermal energy using this latent heat can store a larger amount of heat than a method of storing thermal heat using sensible heat

Meanwhile, phase change materials used as described above can be broadly divided into organic compounds and inorganic salt hydrates. Inorganic salt hydrates have problems in that they show excessive supercooling and phase separation phenomena, and thus, upon long-term use, their performance as phase change materials deteriorates. Organic compounds, including paraffinic hydrocarbons, are disadvantageous in that they are expensive compared to inorganic salt hydrates and have low thermal conductivity, making it difficult to select a melting point having wide range. However, the organic compounds have an advantage in that a supercooling phenomenon does not occur.

The phase change materials as described above can be used in various applications, including building cooling and heating systems and insulation fibers, but for this purpose, the phase change materials should first be encapsulated.

In examples showing encapsulation of the phase change materials, Korean Patent Laid-Open Publication No. 2003-0018155 discloses an encapsulation method comprising preparing microparticles by emulsification with a surfactant and then microencapsulating the microparticles either by the polymerization of monomers or by the use of a tangential spray coater. Also, Korean Patent Laid-Open Publication No. 2002-0056785 discloses a microcapsule containing a nucleating agent for the prevention of supercooling within a phase change material in the form of a single core.

However, when the disclosed phase change material is damaged by physical force or heat, a portion of the capsule will be broken, and thus, upon phase change from solid to liquid, the phase change material present at the core of the capsule will flow to the outside.

Also, Korean Patent Registration Nos. 008262 and 0284192 disclose a method comprising dropping a molten phase change material into a liquid at low temperature, to solidify the molten material, and coating the solidified material with a polymer. However, this method has problems in that the process is complicated, and the prepared capsule containing the phase change material has a diameter of 0.1-11 mm, therefore the method is not suitable for the preparation of a microcapsule.

Moreover, Korean Patent Registration Nos. 0263361 and 0272616 disclose a method of encapsulating paraffin with urea and melamine by interfacial polymerization, in-situ polymerization or coacervation. This method can prepare capsules a few to tens of micrometers in diameter, but has a problem in that the prepared capsules have non-uniform particle size.

Furthermore, Korean Patent Laid-Open Publication Nos. 2002-0078220 and 2003-0072429 disclose a method of preparing a microcapsule having a diameter of 0.9 μm by encapsulating paraffin with one compound selected from diethylenetriamine, ethylenediamine, tiethylenetetramine and melamine solutions. However, this method has a problem in that a large amount of a nonpolar organic solvent is used.

Also, U.S. Pat. No. 5,290,904 discloses a method of preparing a microcapsule containing paraffinic hydrocarbon, but the prepared microcapsule has a problem in that physical properties, such as durability, steam permeability and elasticity, are poor. Also, PCT Publication No. WO 01/54809 discloses a method of encapsulating paraffinic hydrocarbon with methacrylic acid and alkyl ester methacrylate, but has a problem in that the thermal property of the resulting acrylic polymer deteriorates at high temperatures.

The above-described methods have problems such as the efficiency of encapsulating the phase change material is low, upon phase change from solid to liquid, or upon contact with an organic solvent at a high temperature; the phase change material present within the capsule leaks to the outside; or the capsule is too large to use in various applications.

### DISCLOSURE OF THE INVENTION

Accordingly, the present invention has been made to solve the above problems occurring in the prior art, and the present invention provides a method for preparing a microcapsule containing a phase change material, comprising first encapsulating an organic phase change material with acrylic resin by polymerization and then further encapsulating the first encapsulated phase change material with melamine or urea resin.

### BEST MODE FOR CARRYING OUT THE INVENTION

The present invention provides a method for preparing a microcapsule containing a phase change material in the following stages: a first encapsulation stage comprising (i)a surfactant material of 0.1%-10% by weight is dissolved into a base of water (ii)a phase change material of 3-50% by weight of the initial water base is added (iii)a first monomer of 10-40% by weight of the phase change material of the previous step is added to form an emlilsified mixture (iv)an initiator of 0.005-1.0% by weight of the water base is added for polymerization that results in the first encapsulation solvent; and a second encapsulation stage comprising (i) a second monomer of 20-50% by weight of the phase change material in step (ii) of the first encapsulation stage is added to the first encapsulation solvent (ii) an aldehyde- or diisocyanate-containing compound of30 -500% by weight of the second monomer of the previous step is crosslinked with the solution of the previous step to complete the method for preparing a microcapsule containing a phase change material.

As conventional methods for storing energy, various methods are known, but the most widely used methods are heat storage methods, which store energy in the form of heat and then recover the energy in the form of heat. The heat storage methods are divided into a sensible heat storage method using the heat capacity of the storage media, and a latent heat storage method using the latent heat of the storage media. The latent heat storage method has been extensively studied because it has a larger energy storage capacity per unit volume and unit weight than the sensible heat storage method. In the latent heat storage method, latent heat storage materials that change phase in the required temperature range are developed and used.

Particularly, the phase change between solid and liquid causes a relatively small change in volume, and thus, the coming and going of latent heat can be made in a limited space without a great change in internal pressure. Accordingly, materials must be selected that not only have a phase change temperature in the specific temperature range requiring heat storage, but also high latent heat Thus, as the phase change material according to the present invention, any material may be used if it has high latent heat and is excellent in thermal and mechanical properties. However, it is preferable to use an organic compound, and more preferably, a saturated paraffinic hydrocarbon with 10-36 carbon atoms, polyethylene glycol, organic oil or wax with a melting point of-30 to 80 ° C., or a mixture of two or more thereof. As the phase change material, a single pure material can be used alone, but in this case it causes phase change over a narrow temperature range. For this reason, to prepare a phase change material which can exhibit phase change over a wide temperature range while involving the capture and release of a large amount of heat, two kinds, and preferably two or three kinds, of phase change materials can be mixed with each other to form an eutectic mixture, or the degree of hydration of the material can be adjusted.

Meanwhile, it is preferable that the material used as the phase change material have the highest possible latent heat per unit mass. However, most materials which can be easily prepared have an energy of 250 J/g, and in some materials, a supercooling phenomenon can occur where, even when their temperature falls below their melting point, neither phase change occurs, nor latent heat is released. To prevent this supercooling phenomenon, a nucleating agent may be added to the phase change material.

As the nucleating agent, a material having an atomic arrangement or lattice size similar to the crystal of the phase change material is mainly used, and its use as a crystalline nucleus can promote the crystallization of the phase change material, thus inhibiting the supercooling phenomenon.

In the inventive microcapsule containing the phase change material, the phase change material is encapsulated with two sequential coating layers formed on the outer peripheral surface thereof. A polymer material used to encapsulate the phase change material may be acrylic resin, melamine resin and/or urea resin. According to the present invention, it is preferable that a microcapsule containing the phase change material is prepared by coating the outer peripheral surface of the phase change material with acrylic resin to form a first coaling layer and then coaling the outer peripheral surface of the coated acrylic resin with melamine or urea resin to form a second coating layer.

Thus, in the present invention, the monomer forming the first coating layer is referred to as a “first monomer”, and the monomer forming the second coating layer is referred to as a “second monomer”.

In the present invention, the first monomer is a material which encapsulates the phase change material by polymerization to form a fust resin layer. As the first monomer, any material may be used if it is a monomer containing an acrylic group, for example, an acrylic monomer compound.

However, it is preferable to use a mixture consisting of 0-80% by weight of methacrylic acid, 20-100% by weight of acrylic ester, and 0-30% by weight of an ethylenically unsaturated monomer. The first monomer can be used in an amount of 10-40% by weight of the phase change material.

In this regard, materials which can be used as the ethylenically unsaturated monomer include crosslinking monomers, such as styrene, vinyl acetate, ethylene glycol dimethacrylate, divinyl benzene, and butanediol dimethacrylate.

In the present invention, the second monomer is a material which encapsulates the outer peripheral surface of the first resin layer by polymerization to form a second resin layer. Examples of materials which can be used as the second monomer include melamine monomers and/or urea monomers, for example, melamine, diethylenetriamine, ethylenediamine, triethylenetetramine, and a mixture thereof. Also, the second monomer can be used in an amount of 20-50% by weight of the phase change material.

In the present invention, the surfactant is used to form microparticles of the phase change material, and any surfactant may be used if it is conventionally used in the art. However, it is preferable to use polyvinyl alcohol, SLS (sodium lauryl sulfate), hydroxyethylcellulose, a mixture of two or more thereof, or a mixture of at least one selected from polyoxyethylene sorbitan monooleate, polyoxyethylene sorbitan monostearate, polyoxyethylene sorbitan monopalmitate and polyoxyethylene sorbitan monolaurate, with at least one selected from sorbitan monolaurate, sorbitan monopalmitate, sorbitan monostearate and sorbitan monooleate. Although the particle size of the phase change material is determined depending on the amount of surfactant used, it is preferable to use the surfactant in an amount of 0.1-10% by weight of water base.

In the present invention, an initiator is used to initiate polymerization, and any initiator may be used if it is conventionally used in the art However, it is preferable to use sodium striate, sulphur dioxide, or ammonium persulphate. The initiator can be used in an amount of 0.005-1.0% by weight of water base.

In the present invention, the compound containing an aldehyde or diisocyanate group is a material involved in the polymerization of the second monomer. This compound can be used in an amount of 30-500% by weight of the second monomer. The aldehyde group of the aldehyde- containing compound reacts with amine groups. For example, in the case where the compound is formaldehyde, it is condensed with two amine groups contained in, for example, melamine, in the presence of an acid catalyst, to produce a polymer. Meanwhile, the isocyanates of the diisocyanate- containing compound bind with a hydroxyl group to produce a compound having a -NHCOO- group. Moreover, the isocyanate groups may also bind with an amine group, in which case two isocyanate groups in diisocyanate bind with an alcohol having a hydroxyl group or with a compound containing a hydroxyl group so as to prodnre a polymer. In this regard, typical materials which can be used as the aldehyde-containing compound include formaldehyde, acetaldehyde and a mixture thereof Typical materials which can be used as the diisocyanate-containing compound include toluene-2,4-diisocyanate, methylene diphenylisocyanate, hexyldiisocyanate, hydrogenated biphenyhnethane diisocyanate, isophorone diisocyanate, triisocyanate, polyisocyanate, or mixtures thereof.

For encapsulating the phase change material to prepare a microcapsule according to the present invention, any method may be used if it is a general microencapsulation method. In the present invention, the microcapsule is prepared by dispersing the phase change material in a water solution by emulsification, and then polymerizing monomers on the emulsion particle, in which the polymerization of the monomers can be performed by interfacial polymerization, in-situ polymerization or coacervation. However, the method for encapsulating the phase change material according to the present invention is preferably performed using a difference in interfacial tension.

The method of the present invention for preparing a microcapsule containing the phase change material will now be described in more detail.

First, a surfactant material of 0.1-10% by weight is dissolved into a base of water and maintained at a temperature of 60-90 ° C. Then, to the above water solution, a phase change material of 3-50% by weight of the water and the acrylic monomer compound(first monomer) of 10-40% by weight of the phase change material are added and emulsified. To the emulsified mixture, an initiator of 0.005-1.0% by weight is added to polymerize the monomer on the phase change material particle so as to form the first coating layer on the particle. In this regard, although the time for polymerization varies depending on the amount of the first monomer, polymerization temperature and the amount of the initiator, it is preferable to carry out the polymerization for a time sufficient to reach a degree of polymerization of 30-95%.

Then, to the emulsion resulting from the polymerization reaction, a melamine or urea monomer (second monomer) is added in an amount of 20-50% by weight of the phase change material. To the second monomer-containing emulsion, the compound containing an aldehyde or diisocyanate group is added in an amount of 30-500% by weight of the second monomer, to form crosslinks, thus forming a second coating layer on the first coating layer.

In this regard, if the second monomer is used in an amount of less than 20% by weight of the phase change material, the second coating layer will be insufficiently formed, resulting in an incomplete microcapsule. If the incomplete microcapsule is heated or brought into contact with a solvent capable of dissolving the phase change material, a phenomenon can occur where the phase change material present within the incomplete microcapsule leaks to the outside. On the other hand, if the second monomer is used in an amount of more than 50% weight of the phase change material, the content of the phase change material in the resulting microcapsule will be low, so that the phase change material will show a reduction in the heat capacity capable of absorbing or storing heat.

Hereinafter, the present invention will be described in more detail by an example. It is to be understood, however, that this example is for illustrative purpose only and is not to be construed to limit the scope of the present invention.

### Example 1

300 ml of a 1.0% aqueous solution of polyvinyl alcohol (Sigma-Aldrich, USA) was added into a reactor. To the aqueous solution maintained at 80 ° C., 30 g of octadecane (Sigma-Aldrich, USA), 3 g of methacrylic acid (Kanto Chemical, Japan), 3 g of methylmethaerylic acid (Sigma-Aldrich,

USA) and 0.2 g of ethyleneglycol methacrylate (Sigma-Aldrich, USA) were added and emulsified.

To the emulsified mixture, 0.1 g of sodium disul fate (Kanto Chemical, Japan) was added and the mixture was subjected to polymerization for about 2 hours with stirring at 300 rpm.

After completion of the polymerization, 10 g of melamine (Junsei Chemical, Japan) and 15 ml of a 37% formaldehyde solution were added to the first polymerized solution, and polymerized for about 5 hours, thus preparing microcapsules containing the phase change material.

The prepared microcapsules containing the phase change material had an average diameter of 0.2 pm. Also, the microcapsules containing the phase change material were extracted with a given amount of n-hexane, and the extract was measured for weight and analyzed with a calorimeter. The 2 0 results showed that more than 98% by weight of the used octadecane (phase change material) was encapsulated.

Although the preferred embodiment of the present invention has been disclosed for illustrative purposes, those skilled in the art will appreciate that the present invention can be practiced in other embodiments without changes in the technical ideas or essential features thereof. Accordingly, it is to be understood that the above-described embodiment is for illustrative purposes only and is not to be construed to limit the scope of the present invention. Also, it should be interpreted that all modifications, additions and substitutions derived from the accompanying claims and equivalents thereof are within the scope of the present invention.

### INDUSTRIAL APPLICABILITY

According to the present invention the microcapsule containing the phase change material includes two coating layers for protecting the phase change material, so that the phase change material present within the microcapsule does not leak to the outside. Also, the microcapsule has a compact structure and can be prepared in the form of a particle having a size of the micrometer level or smaller, so that it has high thermal conductivity leading to high thermoresponsivity.

1. A method for preparing a microcapsule containing a phase change material, the method comprising:
a first encapsulation stage comprising adding a phase change material of 3-50% by weight of the water base to a surfactant-containing solution of 0.1-10% by weight of water, adding a first monomer of 10-40% by weight of the phase change material to the surfactant-containing solution so as to form an emulsified mixture, adding an initiator of 0.005-1.0% by weight of the initial water base to the emulsified mixture, thereby polymerizing the initiator-containing mixture; and
a second encapsulation stage comprising adding a second monomer of 20-50% by weight of the phase change material to the solution containing the first encapsulated phase change material, and adding an aldehyde- or diisocyanate-containing compound of 30-500% by weight of the second monomer of the previous step, which is crosslinked with the solution of the previous step.

2. The method of claim 1, wherein the surfactant-containing solution of 0.1-10% by weight of water has a temperature of 60-90 ° C.

3. The method of claim 1, wherein the phase change material is a saturated paraffinic hydrocarbon with 10-36 carbon atoms, polyethylene glycol, organic oil, wax with a melting point of 30 to 80 ° C., or a mixture of two or more thereof

4. The method of claim 1, wherein the first monomer comprises methacrylic acid of 0-80 wt%, acrylic ester of 20-100 wt%, and an ethylenically unsaturated monomer of 0-30 wt%.

5. The method of claim 1, wherein the second monomer is melamine resin, urea resin or a mixture thereof.

6. The method of claim 1, wherein the aldehyde-containing compound is formaldehyde, acetaldehyde, or a mixture thereof.

7. The method of claim 1, wherein the diisocyanate-containing compound is toluene-2,4-diisocyanate, methylene diphenylisocyanate, hexyldiisocyanate, hydrogenated biphenylmethane diisocyanate, isophorone diisocyanate, triisocyanate, polyisocyanate, or a mixture thereof.
